(19) United States
(12) Patent Application Publication
(10) Pub. No.: US 2012/0262478 A1
(43) Pub. Date: Oct. 18, 2012

(54) INFORMATION PROCESSING DEVICE AND DISPLAY DEVICE

(75) Inventor: Tomohiro Mukai, Suwa-shi (JP)

(73) Assignee: Seiko Epson Corporation, Tokyo (JP)

(21) Appl. No.: 13/442,075

(22) Filed: Apr. 9, 2012

(30) Foreign Application Priority Data
Apr. 15, 2011 (JP) 2011-091225

(51) Int. Cl. G09G 5/00

(52) U.S. Cl. 345/619

(57) ABSTRACT

A CPU of an information processing device performs rendering on document data of a document coordinate system expressing a document to be fitted to a display region of a display device, thereby converting the document data to image data of a device coordinate system, and transmits a parameter used for the conversion, the document data and the image data to the display device.

### BACKGROUND

1. Technical Field

The present invention relates to a technology for converting a coordinate system of data.

2. Related Art

Technologies for displaying information inputted through handwriting on an input device such as a touch panel, a tablet or the like are known. For example, Japanese Laid-open Patent Application 2007-226534 (Patent Document 1) describes a technology for displaying information written through a touch panel on an information display panel having display memory property.

With the display device described in Patent Document 1, image display and handwriting input are conducted based on a device coordinate system. For this reason, for example, when displaying an image through converting data specified by a document coordinate system to a device coordinate system, the data of the original document coordinate system and data inputted through handwriting cannot be merged as is.

### SUMMARY

In accordance with an advantage of some aspects of the invention, when displaying an image in a display region by rendering data of a first coordinate system expressing a document, and when an image is written in the display region by handwriting operation, a device in accordance with an aspect of the invention is capable of adding handwritten data expressing the content written in the display region to the data of the first coordinate system.

In accordance with an aspect of the invention, an information processing device includes a first conversion section that converts first data of a first coordinate system expressing a document to second data of a second coordinate system by rendering the first data to be adjusted to a display region of a display device, and a transmission section that transmits a parameter used for conversion by the first conversion section, the first data and the second data to the display device. According to the information processing device, it is possible to provide a device in which, when displaying an image in the display region by rendering data of a first coordinate system expressing a document, and when an image is written in the display region by handwriting operation, handwritten data expressing the content written in the display region can be added to the data of the first coordinate system.

The information processing device may be equipped with a reception section that receives, from the display device, the first data and the parameter transmitted by the transmission section, and first handwritten data of the second coordinate system expressing the content written in the display region by handwriting operation, a second conversion section that converts the first handwritten data received to second handwritten data of the first coordinate system based on the parameter received by the reception section, and an addition section that adds the second handwritten data converted by the second conversion section to the first data received by the reception section. According to this structure, handwritten data expressing contents written in the display region by handwriting operation can be added to data of the first coordinate system expressing a document.

In accordance with a second aspect of the invention, an information processing device includes a first conversion section that converts first data of a first coordinate system expressing a document to second data of a second coordinate system by rendering the first data to be adjusted to a display region of a display device, a storage control section that correlates identification information that identifies the first data with a parameter used for conversion by the first conversion section and stores the same in a storage section, and a transmission section that transmits the identification information and the second data to the display device. According to the information processing device described above, it is possible to provide a device in which, when displaying an image in the display region by rendering data of the first coordinate system expressing a document, and when an image is written in the display region by handwriting operation, handwritten data expressing the content written in the display region can be added to the data of the first coordinate system.

The information processing device in accordance with the second aspect may be equipped with a reception section that receives, from the display device, the identification information transmitted by the transmission section, and first handwritten data of the second coordinate system expressing the content written in the display region by handwriting operation, a second conversion section that converts the first handwritten data received to second handwritten data of the first coordinate system based on the parameter correlated with the identification information received by the reception section and stored in the storage section, and an addition section that adds the second handwritten data converted by the second conversion section to the first data identified by the identification information received by the reception section. According to this structure, handwritten data expressing contents written in the display region by handwriting operation can be added to data of the first coordinate system expressing a document.

According to the information processing device described above, when converting the first data to the second data, the first conversion section enlarges, reduces, rotates and/or shifts a region in which the image is displayed based on the second data such that the region is inscribed in the display region in the center of the display region, and the parameter may include information indicative of a paper size set for the document expressed by the first data, a pixel density of the second data, a rotation angle of the region in which the image is displayed based on the second data, or coordinates of the region in the second coordinate system. According to this structure, the image based on the second data is displayed in a manner contained within the display region.

In accordance with a third aspect of the invention, a display device includes a first conversion section that converts first data of a first coordinate system expressing a document to second data of a second coordinate system by rendering the first data to be adjusted to a display region of a display device, a display control section that displays an image based on the second data converted by the first conversion section in the display region, a creation section that creates first handwritten data expressing contents written in the display region by handwriting operation based on the second coordinate system, a second conversion section that converts the first handwritten data created by the creation section to second handwritten data of the first coordinate system based on a parameter used for conversion by the first conversion section, and an addition section that adds the second handwritten data converted by the second conversion section to the first data. According to the display device, handwritten data expressing contents written in the display region by handwriting operation can be added to the data of the first coordinate system expressing a document.

According to the display device described above, when converting the first data to the second data, the first conversion section enlarges, reduces, rotates and/or shifts a region in which the image is displayed based on the second data such that the region is inscribed in the display region in the center of the display region, and the parameter may include information indicative of a paper size set for the document expressed by the first data, a pixel density of the second data, a rotation angle of the region in which the image is displayed based on the second data, or coordinates of the region in the second coordinate system. According to this structure, the image based on the second data is displayed in a manner contained within the display region.

### BRIEF DESCRIPTION OF THE DRAWINGS

FIG. 1 is a schematic view showing the structure of a display system.

FIG. 2 is a schematic diagram of the structure of an information processing device.

FIG. 3 is a schematic diagram of the structure of a display device.

FIG. 4 is a schematic diagram of the functional structure of a display system.

FIG. 5 is a sequence diagram showing operations of the display system.

FIG. 6 is a diagram for describing an example of a conversion operation.

FIG. 7 is a diagram showing an example of conversion information.

FIG. 8 is a diagram showing an example of a data package.

FIG. 9 is a view showing an example of contents written in a display region by handwriting operation.

FIG. 10 is a diagram showing an example of a data package.

### PREFERRED EMBODIMENTS

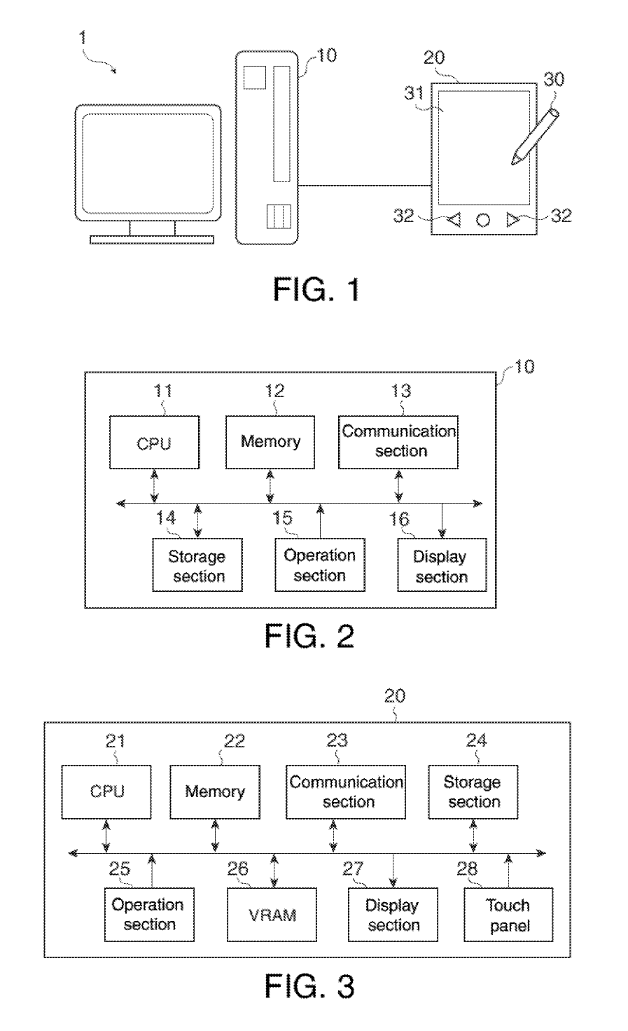

FIG. 1 is a view showing the structure of a display system 1 in accordance with an embodiment of the invention. The display system 1 is equipped with an information processing device 10, a display device 20, and a stylus pen 30. The information processing device 10 has a function to create document data or display a document, based on a document coordinate system (an example of the first coordinate system). The document coordinate system is a coordinate system that specifies positional relations based on a paper size set for the document. The display device 20 has a function to display an image based on a device coordinate system (an example of the second coordinate system). The device coordinate system is a coordinate system based on the number of pixels corresponding to a display resolution of the display device 20. The stylus pen 30 is used by the user to perform handwriting operation on the display device 20.

FIG. 2 is a diagram showing the structure of the information processing device 10. The information processing device 10 includes a CPU (Central Processing Unit) 11, a memory 12, a communication section 13, a storage section 14, an operation section 15, and a display section 16. The CPU 11 executes programs thereby controlling each of the sections of the information processing device 10. The memory 12 stores the programs that are executed by the CPU 11. The communication section 13 is a communication interface for communications with the display device 20 through a communication cable. The storage section 14 is equipped with, for example, a hard disk that stores various programs and data. The storage section 14 stores a printer driver and a viewer. The printer driver has a function to convert data of a document coordinate system to data of a device coordinate system. The viewer has a function to display a document based on the data of the document coordinate system. Also, the storage section 14 stores document data 41 specified by the document coordinate system (an example of the first data). The document data 41 expresses a document including one or more pages. The document data 41 may be created by, for example, a document creation function, and stored in the storage section 14. The operation section 15 is equipped with, for example, a mouse and a keyboard, and may be used when the user operates the information processing device 10. The display section 16 is equipped with, for example, a liquid crystal display, and displays an image.

FIG. 3 is a diagram showing the structure of the display device 20. The display device 20 includes a CPU 21, a memory 22, a communication section 23, a storage section 24, an operation section 25, a VRAM (Video RAM) 26, a display section 27, and a touch panel 28. The CPU 21 executes programs, thereby controlling each of the sections of the display device 20. The memory 22 stores programs to be executed by the CPU 21. The communication section 23 is a communication interface for communications with the information processing device 10 through the communication cable. The storage section 24 is equipped with, for example, a flash memory, and stores various data. The operation section 25 is equipped with buttons 32 used for operation of the display device 20. The VRAM 26 stores image data expressing an image to be displayed on the display section 27. The display section 27 may be, for example, an electrophoretic type electronic paper, and displays an image in a display region 31. The display region 31 includes pixels in a number of “width of 1650 pixels×height of 2400 pixels.” The touch panel 28 is equipped with a detection surface provided superposed on the display region 31, and receives handwriting operation by the user. More specifically, the handwriting operation is an operation of moving the stylus pen 30 while the tip of the stylus pen 30 is placed in contact with the detection surface of the touch panel 28. The touch panel 28 uses, for example, a resistance film system, and detects coordinates of dots contacted by the stylus pen 30 through handwriting operation based on the device coordinate system.

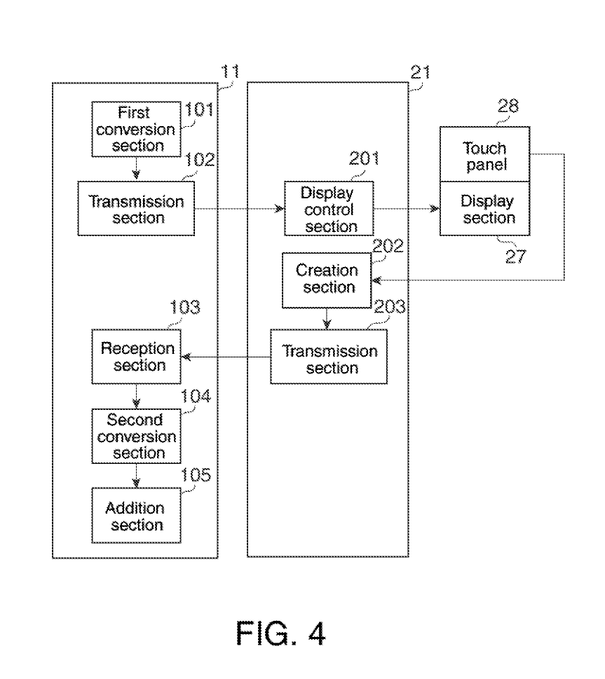

FIG. 4 is a diagram showing the functional structure of the display system 1. The CPU 11 of the information processing device 10 executes programs, thereby realizing a first conversion section 101, a transmission section 102, a reception section 103, a second conversion section 104, and an addition section 105. The CPU 21 of the display device 20 executes programs, thereby realizing a display control section 201, a creation section 202, and a transmission section 203. The functions of the CPU 11 or the CPU 12 may be realized by a single program, or may be realized by a plurality of programs. The first conversion section 101 convers document data of a document coordinate system expressing a document to image data of a device coordinate system through rendering the document data to fit to the display region 31 of the display device 20. The transmission section 102 transmits parameters used for the conversion by the first conversion section 101, the document data and the image data to the display device 20.

The display control section 201 displays an image in the display region 31 based on the image data transmitted by the transmission section 102. The creation section 202 creates first handwritten data expressing contents written in the display region 31 by handwriting operation based on the device coordinate system. The transmission section 203 transmits the document data and the parameters transmitted by the transmission section 102, and the first handwritten data created by the creation section 202 to the information processing device 10. The reception section 103 receives the document data, the parameters and the first handwritten data transmitted from the display device 20. The second conversion section 104 converts the received first handwritten data to second handwritten data of the document coordinate system based on the parameters received by the reception section 103. The addition section 105 adds the second handwritten data converted by the second conversion section 104 to the document data received by the reception section 103.

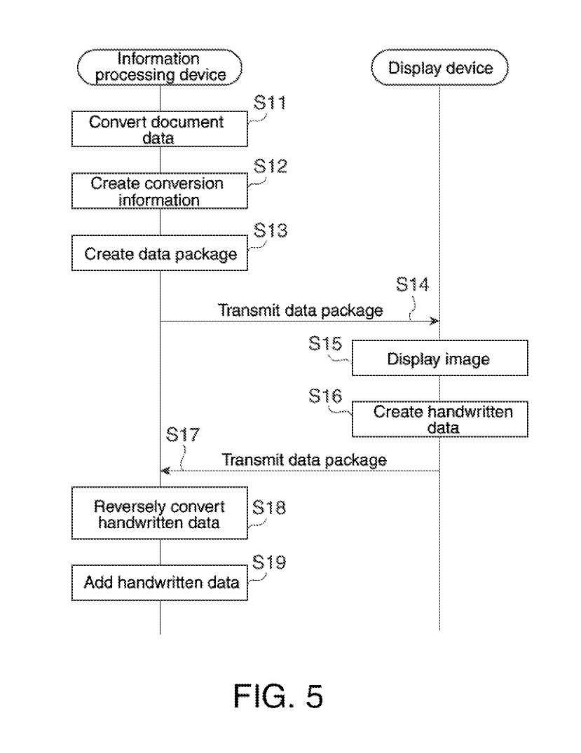

FIG. 5 is a sequence diagram showing the operation of the display system 1. The operation is executed, when an instruction to transmit the document data 41 to the display device 20 is inputted by, for example, the user's operation. When the instruction is inputted, the CPU 11 executes the printer driver stored in the storage section 14, thereby performing processings in the following steps S11 through S14. In step S11, the CUP 11 reads out the document data 41 stored in the storage section 14, and performs rendering on the document data 41 so as to be fitted to the display region 31 of the display device 20. Rendering is the process of generating an image from information given as data by means of calculation. By the rendering, the document data 41 of the document coordinate system is converted to image data 42 of the device coordinate system (an example of the second data). It is noted that the rendering is executed for each page of the document data 41. Therefore, the image data 42 is created for each of the pages.

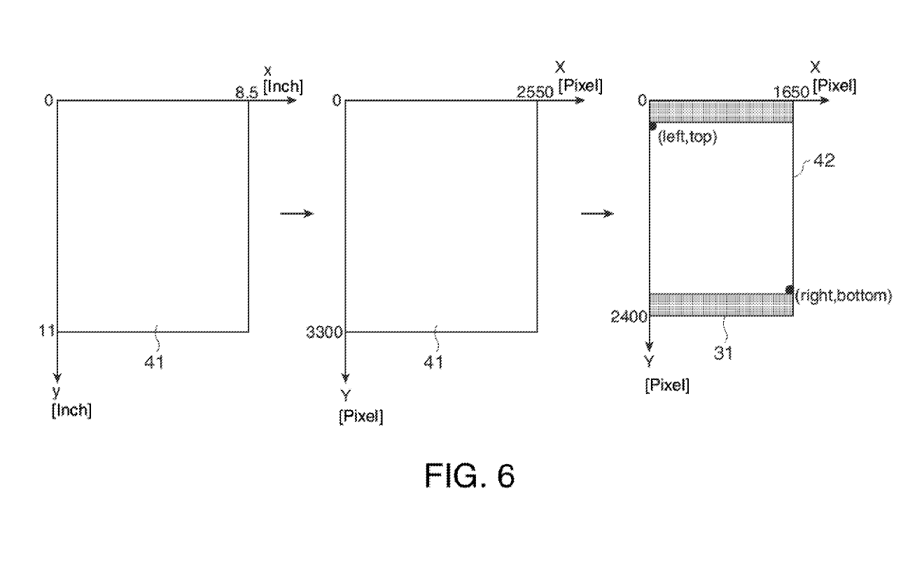

FIG. 6 is a diagram for describing an example of the conversion. Here, it is assumed that the pixel density to be used for rendering is set to 300 dpi (dots per inch). The CPU 11 calculates the number of pixels of the paper size of the document data 41 when the document data 41 is rendered with 300 dpi. In this example, the paper size of the document data 41 is a portrait letter size of 8.5 inches×11 inches. In this case, the paper size of the document data 41 is equivalent to “2550 pixels in width×3300 pixels in height” as expressed in the number of pixels.

Next, the CPU 11 compares the calculated number of pixels of the paper size with the number of pixels of the display region 31 of the display device 20, and adjusts a drawing region of the image data 42 to fit with the number of pixels of the display region 31. The drawing region is a region where an image is displayed based on the image data 42. Here, the drawing region of the image data 42 is adjusted to be inscribed in the display region 31 in the center of the display region 31. For example, when the number of pixels of the paper size is greater than the number of pixels of the display region 31, the drawing region of the image data 42 is reduced in size while its aspect ratio is maintained constant. In reverse, when the number of pixels of the paper size is smaller than the number of pixels of the display region 31, the drawing region of the image data 42 is enlarged in size while its aspect ratio is maintained constant. Also, when the aspect ratio of the paper size and the aspect ratio of the display region 31 are different from each other, the drawing region of the image data 42 is moved so as to be located in the center of the display region 31. Furthermore, when the aspect ratio of the paper size does not correspond to the aspect ratio of the display region 31, for example, as in the case where the paper size is in a portrait size and the display region 31 is in a landscape size, the drawing region of the image data 42 is rotated through 90 degrees.

In the example shown in FIG. 6, the number of pixels of the paper size is greater than the number of pixels of the display region 31, and the aspect ratio of the paper size is different from the aspect ratio of the display region 31. Therefore, the drawing region of the image data 42 is reduced in size while its aspect ratio is maintained constant, and thereafter moved to be positioned in the center of the display region 31. In this case, the left upper apex of the drawing region of the image data 42 is at coordinates (left, top), and the right lower apex thereof is at coordinates (right, bottom). These coordinates are determined based on the device coordinate system. In this example, as the aspect ratio of the paper size and the aspect ratio of the display region 31 correspond to each other, the drawing region of the image data 42 is not rotated.

In step S12, the CPU 11 creates conversion information 43 based on the contents of the rendering described above. The conversion information 43 includes parameters used for the conversion in step S11. The conversion information 43 is created for each of the pages of the image data 42.

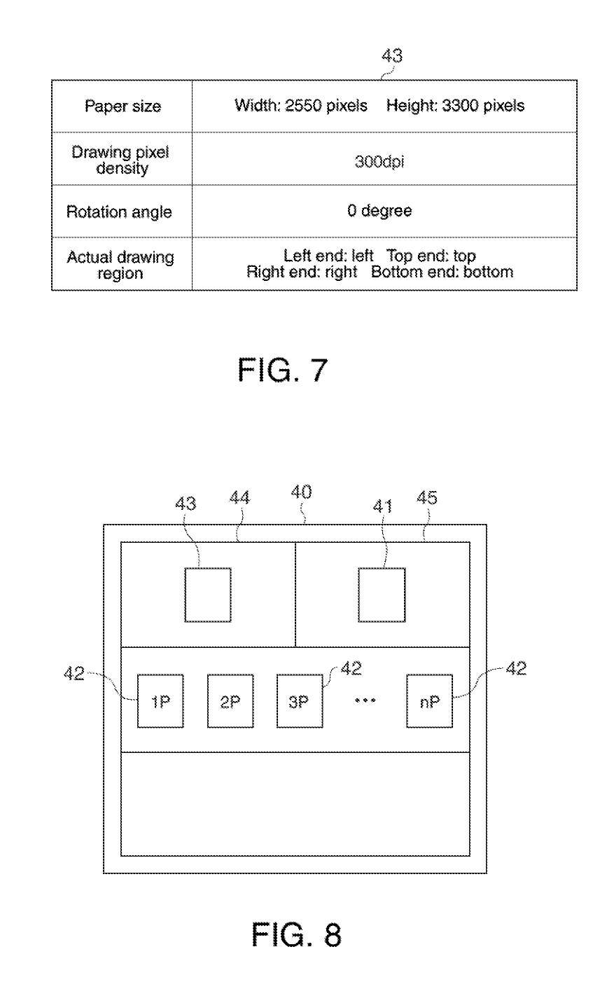

FIG. 7 is a diagram showing an example of the conversion information 43. The conversion information 43 describes information indicative of “paper size,” “drawing pixel density,” “rotation angle” and “actual drawing region.” The “paper size” is information indicative of the paper size set for a document presented by the document data 41 expressed in the number of pixels. In the example shown in FIG. 6, the number of pixels of the paper size of the document data 41 is “2550 pixels in width×3300 pixels in height.” In this case, in the conversion information 43, “2550 pixels” as the number of pixels of the width of the paper size and “3300 pixels” as the number of pixels of the height of the paper size are described. The “drawing pixel density” is indicative of the pixel density used for the rendering, in other words, the pixel density of the image data 42. In the example shown in FIG. 6, the pixel density of “300 dpi” is used in the rendering. In this case, “300 dpi” as information indicative of the drawing pixel density is described in the conversion information 43.

The “rotation angle” is the angle through which the drawing region of the image data 42 is rotated. The “rotation angle” includes the direction of rotation and the amount of rotation. In the example shown in FIG. 6, the drawing region of the image data 42 is not rotated. In this case, in the conversion information 43, “0 degree” is described as information indicative of the angle of rotation. The “actual drawing region” is a drawing region of the image data 42 in the device coordinate system. In the example shown in FIG. 6, the coordinates of the left upper apex of the drawing region of the image data 42 are (left, top), and the coordinates of the right lower apex are (right, bottom). In this case, in the conversion information 43, “left” is described as information indicative of the coordinate of the left end of the actual drawing region, “top” is described as information indicative of the coordinate of the top end, “right” is described as information indicative of the coordinate of the right end, and “bottom” is described as information indicative of the coordinate of the bottom end. In the rendering described above, in the case of moving the drawing region of the image data 42, initially, coordinates of the left upper apex (left, top) and coordinates of the right bottom apex (right, bottom) of the drawing region after having been moved to be positioned in the center of the display region 31 are calculated. Then, the drawing region of the image data 42 is moved based on the calculated coordinates. Therefore, it can be said that the information indicative of the “actual drawing region” is a parameter used for the conversion in step S11.

In step S13, the CPU 11 creates a data package 40. The data package 40 is a collection of the image data 42 created in step S11, management information 44 and an option file 45 put together into one file. The file format of the data package 40 may use, for example, a data compression or archiving format. The management information 44 contains various management information for the data package 40 put together into a file. The management information 44 contains the conversion information 43 created in step S12. The option file 45 is a file that may be added optionally. FIG. 8 is a view showing an example of the data package 40. The data package 40 includes image data 42 for pages 1-n. Also, the management information 44 includes the conversion information 43 shown in FIG. 7. Further, the option file 45 includes the document data 41 in a state prior to conversion in step S11.

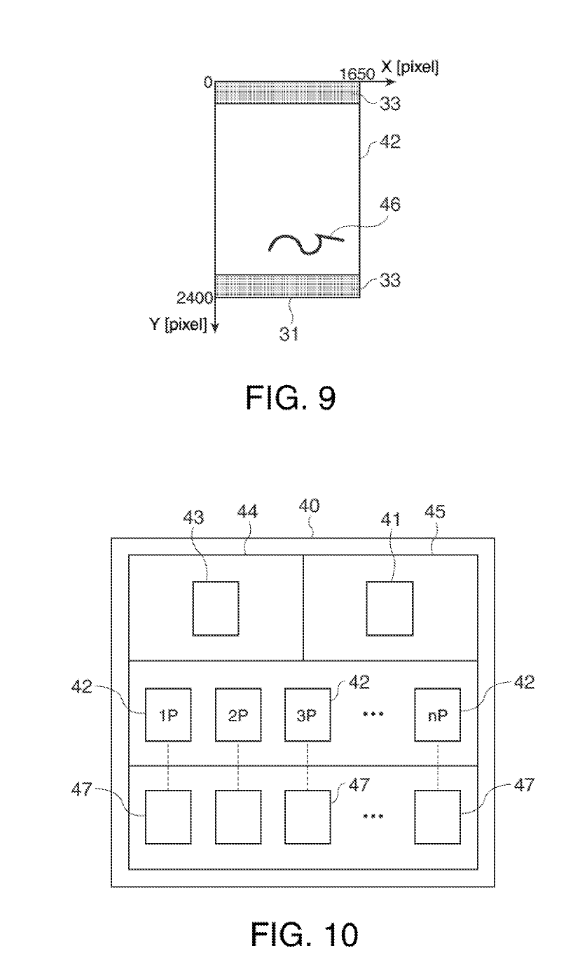

In step S14, the CPU 11 instructs the communication section 13 to transmit the data package 40 created in step S13 to the display device 20. The CPU 21 of the display device 20 receives the data package 40 at the communication section 23. In step S15, the CPU 21 stores the image data 42 included in the received data package 40 in the VRAM 26. The display section 27 displays an image in the display region 31 based on the image data 42 stored in the VRAM 26. After the image is displayed in the display region 31, the user may use the stylus pen 30 to perform handwriting operation on the image displayed in the display region 31. FIG. 9 is a view showing an example of the content written in the display region 31 by the handwriting operation. In this example, a line image 46 is written by the handwriting operation. The line image 46 is composed of a plurality of points connected together. When the line image 46 is written in the display region 31 by the handwriting operation, the touch panel 28 detects coordinates of the points composing the line image 46.

In step S16, the CPU 21 creates handwritten data 47 expressing the contents written in the display region 31 by the handwriting based on the device coordinate system. The handwritten data 47 includes sets of coordinate information expressing the coordinates detected by the touch panel 28. In the handwritten data 47, the coordinate information sets of the continuous points are tied together as information of one stroke. Further, in the handwritten data 47, sets of information of a series of strokes are tied together as information of one session. For example, information sets of strokes composing one character are tied together as information of one session. The information of each session includes information indicative of attribute information (e.g., line type, line thickness, etc.) of the stylus pen 30, update date and time information indicative of the date and the time when the handwriting operation is performed, user name information of the user who performed the handwriting operation. The user name may be inputted by the user, for example, when the user starts using the display device 20.

In step S17, the CPU 21 adds the handwritten data 47 created in step S16 to the data package 40 received from the information processing device 10. Then, the CPU 21 instructs the communication section 23 to transmit the data package 40 to the information processing device 10. FIG. 10 is a diagram showing an example of the data package 40. The data package 40 includes sets of the handwritten data 47 for the pages 1-n added to sets of the image data 42 for the pages 1-n, respectively.

The CPU 11 of the information processing device 10 receives the data package 40 transmitted from the display device 20 at the communication section 13. In step S18, the CPU 11 retrieves the conversion information 43 and the handwritten data 47 from the received data package 40. Then, the CPU 11 reversely converts the handwritten data 47 of the device coordinate system to the handwritten data 48 of the document coordinate system based on the conversion information 43.

In the reverse conversion, conversion with contents opposite to the conversion contents performed in the rendering in step S11 is performed. For example, when the drawing region of the image data 42 is reduced in size in the rendering, the drawing region of the handwritten data 47 is expanded to have the size prior to reduction. On the other hand, when the drawing region of the image data 42 is expanded in size in the rendering, the drawing region of the handwritten data 47 is reduced in size to have the size prior to expansion. Also, when the drawing region of the image data 42 is shifted in the rendering, the drawing region of the handwritten data 47 is shifted in a direction opposite to the shift direction and by the shift amount of the drawing region of the image data 42. Further, when the drawing region of the image data 42 is rotated in the rendering, the drawing region of the handwritten data 47 is rotated in a direction opposite to the rotation direction and by the rotation amount of the drawing region of the image data 42.

In the example shown in FIG. 6, the drawing region of the image data 42 is reduced in size while maintaining the aspect ratio constant, and thereafter shifted so as to be located in the center of the display region 31. In this case, the handwritten data 47 is reversely converted to handwritten data 48 of the document coordinate system by the following conversion formulas (1) and (2). It is noted that, in the formulas (1) and (2), coordinates of the device coordinate system are expressed as (X, Y), and coordinates of the document coordinate system are expressed as (x, y). Also, the unit of the coordinates of the document coordinate system is in inch.

x=((X+0.5−left)/(right−left))×(Width of Paper Size/Drawing Pixel Density) (1)

y=((Y+0.5−top)/(bottom−top))×(Height of Paper Size/Drawing Pixel Density) (2)

It is noted that a value “0.5” is added to each of the coordinate values of X and Y in the conversion formulas (1) and (2) because of the following reason. As the coordinate value “1” in the device coordinate system is a value having a range between 0 and 1, “0.5” is used as its representative value.

In step S19, the CPU 11 adds the handwritten data 48 of the document coordinate system converted in step S18 to the document data 41 of the document coordinate system included in the received data package 40. For example, the CPU 11 adds the handwritten data 48 to the document data 41 as annotation information. By this operation, the handwritten content based on the handwritten data 48 is embedded in the document based on the document data 41. For example, when the handwritten data 48 expressing the line image 46 shown in FIG. 9 is added to the document data 41, and when the CPU 11 executes the viewer stored in the storage section 14, thereby displaying the document based on the document data 41, the line image 46 based on the handwritten data 48 is displayed over the document.

In the embodiment described above, the handwritten data 48 expressing the content written in the display region 31 by handwriting operation is added to the document data 41 of the document coordinate system, such that the user can view the document based on the document data 41 and the handwritten content based on the handwritten data 48 combined together. Also, when the user transmits the document data 41 with the handwritten data 48 added thereto to another user, the other user can view the document based on the document data 41 and the handwritten content based on the handwritten data 48 combined together. Also, in the embodiment described above, complex processings such as mixing the image data 42 of the device coordinate system with the handwritten data 47 are not performed, such that the process requires fewer processings and does not result in a large processing load.

The invention is not limited to the embodiment described above, and may be implemented with modifications. Some of such modifications will be described below. It is noted that these modification examples may be implemented in combination.

### MODIFICATION EXAMPLE 1

In the embodiment described above, the document data 41 is included in the data package 40 and transmitted to the display device 20. However, the document data 41 may not have to be included in the data package 40. For example, the document data 41 may be stored in the storage section 14 of the information processing device 10. Alternatively, the document data 41 may be stored in a storage device that can be accessed by the information processing device 10 and the display device 20. In this case, the CPU 11 of the information processing device 10 includes identification information that identifies the document data 41 in the data package 40 and transmits the data package 40 to the display device 20. The identification information may be, for example, a file name of the document data 41 or information indicative of a storage location of the document data 41. The data package 40 that is transmitted from the display device 20 to the information processing device 10 also includes the identification information. Upon receiving the data package 40, the CPU 11 of the information processing device 10 retrieves, from the storage section 14 or the storage device, the document data 41 identified by the identification information included in the data package 40 received from the display device 20. Then, the CPU 11 adds the handwritten data 48 to the obtained document data 41.

### MODIFICATON EXAMPLE 2

In the embodiment described above, the conversion information 43 is included in the data package 40 and transmitted to the display device 20. However, the conversion information 43 may not have to be included in the data package 40. For example, the CPU 11 (an example of the storage control section) may associate the identification information of the document data 41 with the conversion information 43 and store them in the storage section 14. Alternatively, the CPU 11 may associate the identification information of the document data 41 with the conversion information 43 and store them in a storage device that can be accessed by the information processing device 10 and the display device 20. In this case, the CPU 11 includes identification information that identifies the document data 41 in the data package 40 and transmits the data package 40 to the display device 20. The data package 40 that is transmitted from the display device 20 to the information processing device 10 also includes the identification information. Upon receiving the data package 40, the CPU 11 of the information processing device 10 retrieves, from the storage section 14 or the storage device, the stored conversion information 43 associated with the identification information contained in the data package 40 received from the display device 20. Then, the CPU 11 reversely converts the handwritten data 47 of the device coordinate system into the handwritten data 48 of the document coordinate system based on the obtained conversion information 43.

### MODIFICATION EXAMPLE 3

The document data 41 with the handwritten data 48 added in step S19 may be stored in the storage section 14 of the information processing device 10, or may be stored in a storage device that can be accessed by the information processing device 10 and the display device 20. Alternatively, the document data 41 may be transmitted from the information processing device 10 to the display device 20 and stored in the storage section 24.

### MODIFICATION EXAMPLE 4

The handwritten data 48 may be set with one of different display modes according to the date and time when handwriting operation is conducted. The display mode may refer to, for example, the color, the size, the decoration. For example, let us assume a case in which a first line image is written at 27 minutes past 10 o'clock on March 1^{st} (Mar. 1, 10 hours 27 minutes), and a second line image is written at 30 minutes past 10 o'clock on March 1^{st} (Mar, 1, 10 hours 30 minutes). In this case, information of the session corresponding to the first line image in the handwritten data 48 includes update date and time information of “Mar. 1, 10 hours 27 minutes” and information of the session corresponding to the second line image includes update date and time information of “Mar, 1, 10 hours 30 minutes” When adding the handwritten data 48 to the document data 41, the CPU 11 of the information processing device 10 sets, for example, the color of the first line image expressed by the handwritten data 48 to a red color, and the color of the second line image to a blue color, based on the update data and time information included in the handwritten data 48. In other words, the CPU 11 sets a different display mode on the handwritten data 48 according to the date and time of the execution of handwriting operation. By this, when the first line image and the second line image are displayed based on the handwritten data 48, the first line image and the second line image are shown discriminated one from the other.

### MODIFICATION EXAMPLE 5

Handwriting operation may be performed by multiple users. In this case, the handwritten data 48 may be set with one of different display modes according to the user who performs handwriting operation. For example, let us assume a case where a first line image is drawn in the display region 31 by the first user, and a second line image is drawn in the display region 31 by the second user. In this case, information of the session corresponding to the first line image in the handwritten data 48 includes a user name of the first user, and information of the session corresponding to the second line image includes a user name of the second user. When adding the handwritten data 48 to the document data 41, the CPU 11 of the information processing device 10 sets, for example, the color of the first line image expressed by the handwritten data 48 to a red color, and the color of the second line image to a blue color, based on the user names included in the handwritten data 48. In other words, the CPU 11 sets a different display mode on the handwritten data 48 according to the user who performed handwriting operation. By this, when the first line image and the second line image are displayed based on the handwritten data 48, the first line image and the second line image are shown discriminated one from the other.

### MODIFICATION EXAMPLE 6

Handwriting operation may be performed using multiple stylus pens having different properties. In this case, the handwritten data 48 may be set with one of different display modes according to the property of the stylus pen 30. For example, let us assume a case where a first line image is drawn in the display region 31 by the first stylus pen 30, and a second line image is drawn in the display region 31 by the second stylus 30. The types of lines drawn (hereafter, called “line types”) are different between the first stylus pen 30 and the second stylus pen 30. In this case, information of the session corresponding to the first line image in the handwritten data 48 includes property information indicative of the line type of the first stylus pen 30, and information of the session corresponding to the second line image includes property information indicative of the line type of the second stylus pen 30. When adding the handwritten data 48 to the document data 41, the CPU 11 of the information processing device 10 sets, for example, the color of the first line image expressed by the handwritten data 48 to a red color, and the color of the second line image to a blue color, based on the property information of the stylus pens 30 included in the handwritten data 48. In other words, the CPU 11 sets a different display mode on the handwritten data 48 according to the property of the stylus pen 30 (an example of the operation element) used for handwriting operation. By this, when the first line image and the second line image are displayed based on the handwritten data 48, the first line image and the second line image are shown discriminated one from the other.

### MODIFICATION EXAMPLE 7

When a portion of the content written in the display region 31 is selected by the user, a different display mode may be set for the selected portion on the handwritten data 48. For example, let us assume a case where a plurality of line images are written in the display region 31, and the user selects the first line image. In this case, the handwritten data 48 includes selection information indicating that the first line image has been selected by the user. When adding the handwritten data 48 to the document data 41, the CPU 11 of the information processing device 10 sets, for example, the color of the first line image expressed by the handwritten data 48 to a color different from the color of the other lines, based on the selection information included in the handwritten data 48. In other words, when a portion of the content written in the display region 31 is selected, the CPU 11 sets a different display mode for the selected portion on the handwritten data 48. By this, when the first line image is displayed based on the handwritten data 48, the first line image and the other line images are shown discriminated one from the other.

### MODIFICATION EXAMPLE 8

The display region 31 shown in FIG. 9 includes non-image regions 33 where no image is displayed. For example, the non-image regions 33 may be filled with black such that the user does not perform handwriting operation therein. Alternatively, the non-image regions 33 may be configured to accept handwriting operation by the user. In this case, the CPU 11 of the information processing device 10 adds handwritten data indicative of contents written in the region where the image is displayed to the document data 41, and adds handwritten data indicative of contents written in the non-image region 33, for example, as an electronic tag to the document data 41. Alternatively, the CPU 11 may add handwritten data indicative of contents written in the non-image regions 33 to the document data 41 in a manner that the contents written in the non-image regions 33 are displayed on the next page of the document based on the document data 41. Also, when performing reverse conversion, the CPU 11 may reduce a region that includes contents written in the region where the image is displayed and contents written in the non-image regions 33 to fit to the paper size of the document data 41. By this, when the handwritten contents based on the handwritten data 48 are displayed, the contents written in the region where the image is displayed and the contents written in the non-image regions 33 are displayed in one page.

### EMBODIMENT EXAMPLE 9

In the embodiment described above, the drawing region of the image data 42 is adjusted so as to be inscribed in the display region 31 in the center of the display region 31. However, the method of adjusting the drawing region of the image data 42 to be fitted with the display region 31 is not limited to the aforementioned method. For example, the drawing region of the image data 42 may be adjusted so as to be inscribed in a region smaller than the display region 31, or may be adjusted such that the width or the height of the drawing region of the image data 42 corresponds to the width or the height of the display region 31. Also, the drawing region of the image data 42 may be adjusted such that the left upper apex of the region is positioned at the origin of the display region 31.

### MODIFICATION EXAMPLE 10

A portion or all of the processings performed by the information processing device 10 may be performed by the display device 20. For example, the display device 20 may obtain the document data 41 from the information processing device 10, and may execute the processings shown in FIG. 5 except the processings in step S13, S14 and S17. In this case, the CPU 21 of the display device 20 creates the conversion information 43 in step S12, and stores the created conversion information 43 in the storage section 24. In step S15, the CPU 21 displays an image in the display region 31 based on the image data 42 converted in step S12. The display region 31 may display a button for instructing to add handwritten data 48. When the button is pressed by the user, the CPU 21 performs the processings in step S18 and step S19. In step S18, the CPU 21 converts the handwritten data 47 created in step S16 to handwritten data 48 of the document coordinate system, based on the conversion information 43 stored in the storage section 24. In step S19, the CPU 21 adds the handwritten data 48 to the document data 41 in a state prior to conversion in step S11.

### MODIFICATION EXAMPLE 11

The display section 27 may use a microcapsule-type electrophoretic system, or a partition-wall (micro-cup) type electrophoretic system. Also, the display section 27 may use any systems other than electrophoretic systems. As the systems other than electrophoretic systems, for example, electronic liquid powder systems, cholestric liquid crystal systems, electrochromic systems, and electrowetting systems are available. Also, the display section 27 may be a display device other than an electronic paper, such as, a liquid crystal display, an organic EL (electroluminescence) display or the like.

### MODIFICATION EXAMPLE 12

When the touch panel 28 uses a resistance-film system, the user may perform handwriting operation with fingers instead of the stylus pen 30. Also, the touch panel 28 may use a system other than the resistance-film system, such as, electrostatic capacitance systems, electromagnetic induction systems, or the like. When the touch panel 28 uses an electrostatic capacitance system, a conductive pen or a finger may be used instead of the stylus pen 30 for handwriting operation. Also, when the touch panel 28 uses an electromagnetic induction system, an exclusive electronic pen may be used instead of the stylus pen 30.

### MODIFICATION EXAMPLE 13

The display device 20 may be used for a variety of electronic apparatuses. For example, the display device 20 may be used for a PDA (Personal Digital Assistant), a portable telephone, an electronic book reader, or a portable game console. Also, the information processing device 10 and the display device 20 may wirelessly communicate with each other.

### MODIFICATION EXAMPLE 14

The programs executed by the CPU 11 or the CPU 12 may be provided in a state being stored in a computer readable media, such as, a magnetic media (e.g., a magnetic tape, a magnetic disk (HDD (Hard Disk Drive), FD (Flexible Disk), or the like), an optical media (an optical disk (CD (Compact Disk), DVD (Digital Versatile Disk) or the like), a magneto-optical media, a semiconductor memory or the like, and may be installed on the information processing device 10 or the display device 20. Also, the programs may be downloaded through the network.

The entire disclosure of Japanese Patent Application No. 2011-091225, filed Apr. 15, 2011 is expressly incorporated by reference herein.

What is claimed is:

1. An information processing device comprising:
a first conversion section that converts first data of a first coordinate system expressing a document to second data of a second coordinate system by rendering the first data to be adjusted to a display region of a display device; and
a transmission section that transmits a parameter used for conversion by the first conversion section, the first data and the second data to the display device.

2. An information processing device according to claim 1, comprising:
a reception section that receives, from the display device, the first data and the parameter transmitted by the transmission section, and first handwritten data of the second coordinate system expressing the content written in the display region by handwriting operation,
a second conversion section that converts the first handwritten data received to second handwritten data of the first coordinate system, based on the parameter received by the reception section, and
an addition section that adds the second handwritten data converted by the second conversion section to the first data received by the reception section.

3. An information processing device comprising:
a first conversion section that converts first data of a first coordinate system expressing a document to second data of a second coordinate system by rendering the first data to be adjusted to a display region of a display device;
a storage control section that correlates identification information that identifies the first data with a parameter used for conversion by the first conversion section and stores the same in a storage section; and
a transmission section that transmits the identification information and the second data to the display device.

4. An information processing device according to claim 3, comprising:
a reception section that receives, from the display device, the identification information transmitted by the transmission section, and first handwritten data of the second coordinate system expressing contents written in the display region by handwriting operation;
a second conversion section that converts the first handwritten data received to second handwritten data of the first coordinate system, based on the parameter correlated with the identification information received by the reception section and stored in the storage section; and
an addition section that adds the second handwritten data converted by the second conversion section to the first data identified by the identification information received by the reception section.

5. An information processing device according to any one of claim 1, wherein, when converting the first data to the second data, the first conversion section enlarges, reduces, rotates or shifts a region in which the image is displayed based on the second data such that the region is inscribed in the display region in a center of the display region, and
the parameter includes information indicative of a paper size set for the document expressed by the first data, a pixel density of the second data, a rotation angle of the region in which the image is displayed based on the second data, or coordinates of the region in the second coordinate system.

6. An information processing device according to any one of claim 3, wherein, when converting the first data to the second data, the first conversion section enlarges, reduces, rotates or shifts a region in which the image is displayed based on the second data such that the region is inscribed in the display region in a center of the display region, and
the parameter includes information indicative of a paper size set for the document expressed by the first data, a pixel density of the second data, a rotation angle of the region in which the image is displayed based on the second data, or coordinates of the region in the second coordinate system.

7. A display device comprising:
a first conversion section that converts first data of a first coordinate system expressing a document to second data of a second coordinate system by rendering the first data to be adjusted to a display region of a display device;
a display control section that displays an image based on the second data converted by the first conversion section in the display region;
a creation section that creates first handwritten data expressing contents written in the display region by handwriting operation based on the second coordinate system;
a second conversion section that converts the first handwritten data created by the creation section to second handwritten data of the first coordinate system, based on a parameter used for conversion by the first conversion section; and
an addition section that adds the second handwritten data converted by the second conversion section to the first data.

8. A display device according to claim 7, wherein, when converting the first data to the second data, the first conversion section enlarges, reduces, rotates or shifts a region in which the image is displayed based on the second data such that the region is inscribed in the display region in a center of the display region, and
the parameter includes information indicative of a paper size set for the document expressed by the first data, a pixel density of the second data, a rotation angle of the region in which the image is displayed based on the second data, or coordinates of the region in the second coordinate system.
